(19) United States
(12) Patent Application Publication
(10) Pub. No.: US 2024/0193905 A1
(43) Pub. Date: Jun. 13, 2024

(54) EXECUTION-INFORMATION RECORDING METHOD, EXECUTION-INFORMATION RECORDING DEVICE, PROGRAM, RECORDING MEDIUM, EXECUTION-INFORMATION TRANSMITTING METHOD, AND EXECUTION-INFORMATION TRANSMITTING DEVICE

(71) Applicant: PIPESH NANO SECONDS INC., Tokyo (JP)

(72) Inventors: Masaaki YAMADA, Tokyo (JP); Yoshitaka HIGASHIDA, Tokyo (JP)

(73) Assignee: PIPESH NANO SECONDS INC., Tokyo (JP)

(21) Appl. No.: 18/286,854

(22) PCT Filed: Mar. 29, 2022
(86) PCT No.: PCT/JP2022/015365

§ 371 Date: Oct. 13, 2023

(30) Foreign Application Priority Data
Apr. 13, 2021 (JP) 2021-068051

(51) Int. Cl. G06V 10/26; G01N 35/00; G01N 35/10; G06T 7/00; G06V 20/50

(52) U.S. Cl. CPC G06V 10/273; G01N 35/0099; G01N 35/10; G06T 7/0002; G06V 20/50

(57) ABSTRACT

An execution-information recording method includes: acquiring an image of a specimen aspirating/discharging unit after expelling of a specimen; performing, when a phenomenon that hinders determination has occurred in the specimen aspirating/discharging unit, processing so that the determination is prevented from being hindered by the phenomenon; and recording an evidence obtained by the acquiring of an image and an evidence after the processing in association with each other. An execution-information recording device includes: image acquiring means for acquiring an image of a specimen aspirating/discharging unit after expelling of a specimen; processing means for performing, when a phenomenon that hinders determination has occurred in the specimen aspirating/discharging unit, processing so that the determination is prevented from being hindered by the phenomenon; and recording means for recording an evidence obtained by the acquiring of an image and an evidence after the processing performed by the processing means in association with each other.

### TECHNICAL FIELD

The present invention relates to a method of recording execution information obtained when pre-processing to be performed before a test using a specimen is executed in accordance with a protocol set in advance, a recording device, a program, a recording medium, an execution-information transmitting method, and an execution-information transmitting device.

### BACKGROUND ART

In fields of life science, such as biology, biochemistry, biotechnology, and food science, various tests using specimens are performed. Before the test using a specimen, pre-processing such as so-called dispensing is performed. The dispensing includes transferring, through use of a specimen aspirating/discharging unit (for example, a pipette or a dropper having a tip mounted on its distal end) or the like, a specimen in a specimen container (for example, a tube) to an expelling destination container (for example, a plate).

The pre-processing may be manually performed. Further, in recent years, in some cases, the pre-processing is performed through use of a dispensing device (Patent Literature 1). The dispensing device of Patent Literature 1 is configured to acquire, by image pickup means, images of a tip before and after dispensing to determine whether or not the dispensing has been accurately performed based on an edge of the acquired tip image.

### CITATION LIST

### Patent Literature

[PTL 1] JP 2006-125855 A

### SUMMARY OF INVENTION

### Technical Problem

Incidentally, in some cases, a phenomenon that hinders determination of an expelled amount, such as a film, air bubbles, and the like, occurs in the tip after dispensing, and this phenomenon may cause a delay or a fallacy of execution of the pre-processing. However, Patent Literature 1 described above does not consider such a phenomenon in performing determination using an image, and hence there is a fear in that whether or not the dispensing is proper cannot be accurately determined.

The present invention has been made in view of the above-mentioned circumstance, and its object to achieve is to be capable of accurately determining an expelled amount even when a phenomenon that hinders determination of the expelled amount has occurred.

### [Execution-Information Recording Method]

An execution-information recording method according to the present invention is a method for recording execution information obtained when pre-processing to be performed before a test using a specimen is executed in accordance with a protocol set in advance. The pre-processing includes a step of expelling a specimen in a specimen aspirating/discharging unit to an expelling destination container. The execution-information recording method includes the steps of: acquiring an image of the specimen aspirating/discharging unit after the expelling of the specimen; performing, when a phenomenon that hinders determination of an expelled amount of the specimen has occurred in the specimen aspirating/discharging unit, processing so that the determination is prevented from being hindered by the phenomenon; and recording an evidence obtained by the acquiring of an image and an evidence after the Processing in Association with Each Other.

### [Execution-information Recording Device]

An execution-information recording device according to the present invention is a device for recording execution information obtained when pre-processing to be performed before a test using a specimen is executed in accordance with a protocol set in advance. The pre-processing includes a step of expelling a specimen in a specimen aspirating/discharging unit to an expelling destination container. The execution-information recording device includes: image acquiring means for acquiring an image of the specimen aspirating/discharging unit after the expelling of the specimen; processing means for performing, when a phenomenon that hinders determination of an expelled amount of the specimen has occurred in the specimen aspirating/discharging unit, processing so that the determination is prevented from being hindered by the phenomenon; and recording means for recording an evidence obtained by the acquiring of an image and an evidence after the processing performed by the processing means in association with each other.

### [Program and Recording Medium]

A program according to the present invention is a program for causing a computer to operate as the execution-information recording device, and a recording medium according to the present invention is a computer-readable recording medium having this program recorded thereon. The computer referred to here is not limited to an electronic computer (PC) to be described later, and is a concept including various devices forming the execution-information recording device, such as a robot, reading means, image acquiring means, and a lighting unit.

### [Execution-Information Transmitting Method]

An execution-information transmitting method according to the present invention is a method for transmitting, to an external device, execution information obtained when pre-processing to be performed before a test using a specimen is executed in accordance with a protocol set in advance. The execution-information transmitting method includes transmitting, to the external device via a communication line, one or two or more pieces of execution information selected from among pieces of execution information recorded by the execution-information recording method of the present invention.

### [Execution-Information Transmitting Device]

An execution-information transmitting device according to the present invention is a device for transmitting, to an external device, execution information which is a record obtained when pre-processing to be performed before a test using a specimen is executed in accordance with a protocol set in advance. The execution-information transmitting device includes a communicating unit configured to transmit, to the external device via a communication line, one or two or more pieces of execution information selected from among pieces of execution information recorded in recording means by the execution-information recording device of the present invention.

### Advantageous Effects of Invention

In the present invention, when a phenomenon that hinders the determination of the expelled amount of the specimen has occurred in the specimen aspirating/discharging unit, processing is performed so that the determination of the expelled amount of the specimen is prevented from being hindered by this phenomenon, and hence the expelled amount can be accurately determined.

### BRIEF DESCRIPTION OF DRAWINGS

FIG. 1 is a flow chart for illustrating an example of pre-processing of a test using a specimen.

FIG. 2 (a) to FIG. 2 (d) are operation explanatory views at the time when the specimen is drawn.

FIG. 3 (a) shows an example of a tip image after drawing, and FIG. 3 (b) is an explanatory view of an air part and a specimen part in the tip image after drawing as illustrated in FIG. 3 (a).

FIG. 4 (a) to FIG. 4 (c) are operation explanatory views at the time when the specimen is expelled.

FIG. 5 (a) shows an example of a tip image after expelling, FIG. 5 (b) is an explanatory view of an air part and a remaining specimen part in the tip image after expelling as illustrated in FIG. 5 (a), and FIG. 5 (c) is an explanatory view of the air part and the remaining specimen part in a case in which a part of the tip image after expelling as illustrated in FIG. 5 (a) is blacked out.

FIG. 6 is a configuration explanatory view for illustrating an example of a system for executing the pre-processing of the test using a specimen.

FIG. 7 is a functional block diagram for illustrating an example of the system for executing the pre-processing of the test using a specimen.

FIG. 8 (a) is a perspective view for illustrating an example of a tube vice before clamping a tube, and FIG. 8 (b) is a perspective view for illustrating an example of the tube vice in a state of clamping the tube.

FIG. 9 is a perspective view for illustrating an example of a deep well plate and a plate seat.

FIG. 10 is a perspective view for illustrating an example of a tip rack and a tip rack case.

FIG. 11 is a functional block diagram for illustrating an example of a configuration of a PC.

### DESCRIPTION OF EMBODIMENTS

### Embodiment

An example of an embodiment of the present invention is described with reference to the drawings. The present invention relates to a method and device for recording execution information obtained in a process of pre-processing of a test using a specimen, which is executed by a robot 30. Before the execution-information recording method and the execution-information recording device are specifically described, meaning of terms used in this application is described.

The “test using a specimen” of this application includes a test of analyzing a base sequence of a nucleic acid and a test of analyzing an amino acid sequence. Specifically, the “test using a specimen” of this application includes a test of analyzing a base sequence of a nucleic acid (for example, a base sequence of a gene) through use of a sequencer (for example, a next-generation sequencer), a test of analyzing an amino acid sequence through use of a peptide sequencer (protein sequencer) capable of automatizing an Edman method, which is one type of analysis method for the amino acid sequence, and the like. In some cases, expressions such as testing and measuring are used instead of analyzing, but the analyzing of this application is a concept including testing, measuring, and the like.

The specimen which is a target of the pre-processing in this application includes feces, urine, saliva, skin, body hair, intestinal microbiota (intestinal flora), and the like. Those specimens are not limited to those collected from human, and include those collected from various animals (such as mammals, fish, birds, amphibians, and reptiles), insects, shellfish, crops, plants, seeds and seedlings thereof, microorganisms, and the like.

The specimen referred to in this application also includes, in addition to the specimen itself, one obtained by adding a buffer solution (buffer component) having a buffer action to the specimen (hereinafter also referred to as “specimen liquid”). For the sake of convenience of description, in this application, the specimen itself or the specimen liquid is expressed as “specimen” unless particular distinction is required. The buffer action referred to here refers to an action in which, even when a small amount of acid or base is added, the influence of this addition is reduced so that pH is kept substantially constant.

The buffer solution includes, for example, a phosphoric acid buffer solution, an acetic acid buffer solution, a citric acid buffer solution, a citric acid phosphoric acid buffer solution, a boric acid buffer solution, a tartaric acid buffer solution, a tris buffer solution, and a McIlvaine buffer solution. One kind or two kinds or more of the buffer solutions are added depending on the specimen.

The specimen liquid of this application also includes one in a form of suspension in which solid particles of the specimen, such as feces, are dispersed. The specimen liquid obtained by adding the buffer solution to the specimen has a feature in that a phenomenon such as a film or air bubbles is liable to occur in a tip Z or in a tube X to be described later.

Further, it is general to preserve the specimen remaining inside the tube X after the specimen drawn from the tube X is expelled into an expelling destination container (for example, a plate such as a deep well plate) 18 to be described later. In this case, it is important to cap the tube X and ensure its tightness so that the nucleic acid in the cell of the specimen remaining inside of the tube X is prevented from being denatured.

The pre-processing of this application is performed at a pre-stage of the test using a specimen (for example, a test of analyzing a base sequence of a gene or an amino acid sequence of a protein), and means processing to be executed by a pre-processing executing system including the robot 30 to be described later.

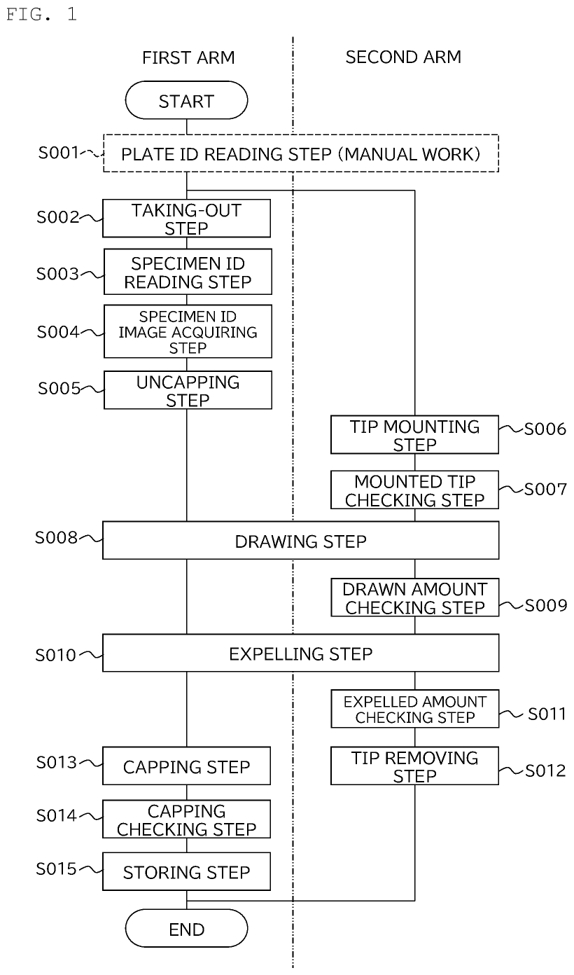

As an example, the pre-processing of this application includes, as illustrated in FIG. 1, a plate ID reading step S001, a taking-out step S002, a specimen ID reading step S003, a specimen ID image acquiring step S004, an uncapping step S005, a tip mounting step S006, a mounted tip checking step S007, a drawing step S008, a drawn amount checking step S009, an expelling step S010, an expelled amount checking step S011, a tip removing step S012, a capping step S013, a capping checking step S014, a storing step S015, and the like. The pre-processing of this application is not limited to a case of including all of those steps, and, in some cases, only a part thereof is included.

In this embodiment, the pre-processing is executed by the pre-processing executing system including the robot 30 to be described later, and various kinds of execution information obtained in the process of executing this pre-processing are recorded. This pre-processing executing system includes the robot 30 and an electronic computer (hereinafter referred to as “PC”) 40, and the pre-processing (entire process described above) is executed in accordance with a protocol registered in both or any one of the robot 30 and the PC 40.

The protocol is an execution procedure manual in which a processing procedure, processing conditions, and the like of the pre-processing are prescribed, and is registered in both or any one of the robot 30 and the PC 40 before the steps of the embodiment are started. The protocol varies in contents depending on characteristics of the specimen, a specification of a test performed after the pre-processing, and the like. In some cases, the protocol includes matters set on a pre-processing executing side. The protocol may be registered in devices other than the robot 30 or the PC 40 (for example, a device including a function corresponding to a processor, a memory, or the like of the robot 30 or the PC 40). Further, when one robot 30 (pre-processing executing system) is responsible for pre-processing corresponding to a plurality of protocols, unique protocol IDs may be applied to the plurality of protocols, respectively.

In the protocol, with reference to three-dimensional (XYZ) work space coordinates set through use of the robot 30 serving as a reference, an operation start point, an operation path, an operation posture, an operation end point, a stop posture, a moving speed, a via point, an operation time period, and the like of the robot 30 are prescribed. In addition, in some cases, a part or the whole of the number of revolutions, a pressure, and the like of a first hand 31a and a second hand 32a is prescribed.

In addition, in the protocol, details of a reading method performed by reading means 13, an image acquiring method performed by image acquiring means 14, a grasping method performed by a tube vice 16 or the like, a drawing reference amount of the specimen, an expelling reference amount of the specimen, a determining method of an drawn amount, a determining method of an expelled amount, an uncapping method, a determining method of uncapping, a capping method, a determining method of capping, a processing method of an evidence, a recording method of execution information obtained in each step, and the like are prescribed. The “time” of the processing or the determination in each of the steps is also recorded as the execution information.

In this embodiment, although an operation of the robot 30 in the protocol is registered in the robot 30, and determination and processing branch instructions of the robot 30 accompanied therewith are registered in the PC 40, the whole or a part of the protocol can be registered in both or any one of the robot 30 side and the PC 40 side. In executing the registered protocol, the individual determination or instruction can also be performed on the PC 40 side.

Further, in this embodiment, regarding records (execution information) of the operation executed based on the registered protocol, after the execution, the operation of the robot 30 is recorded in the robot 30, and the determination (including an evidence) and the processing condition branch are recorded on the PC 40 side. After the execution, the whole or any part of the records (execution information) of the operation executed based on the registered protocol, including operations of the reading means 13, the image acquiring means 14, the tube vice 16, and the like, can also be recorded in both or any one of the robot 30 and the PC 40. Further, the whole or a part of execution records (execution results, evidences, and the like) of reading, determination, and instruction performed based on the registered protocol can also be recorded in both or any one of the robot 30 and the PC 40. The execution information may be recorded in devices other than the robot 30 or the PC 40 (for example, a device having a function corresponding to a processor, a memory, or the like of the robot 30 or the PC 40). The contents of the registration are omitted herein.

In view of the above, one example of each of an execution-information recording method, an execution-information recording device, a program, a recording an medium, and execution-information transmitting method, an execution-information transmitting device of the present invention is described. The execution-information recording method and the execution-information recording device of the present invention are a method and device for recording execution information acquired in each step of pre-processing. The execution information acquired in each step of the pre-processing is automatically recorded into a storage 43 while being associated with specimen identification information or/and protocol identification information, which are to be described later, and the like for each specimen. This recording is automatically performed simultaneously with execution of each round of processing (immediately after the execution).

### [Overview of Flow of Pre-Processing]

FIG. 1 shows an example of a flow chart of pre-processing to be performed before a test using a specimen. The pre-processing of FIG. 1 includes a plate ID reading step S001, a taking-out step S002, a specimen ID reading step S003, a specimen ID image acquiring step S004, an uncapping step (opening step) S005, a tip mounting step S006, a mounted tip checking step S007, a drawing step S008, a drawn amount checking step S009, an expelling step S010, an expelled amount checking step S011, a tip removing step S012, a capping step (closing step) S013, a capping checking step S014, and a storing step S015. As described above, each of the steps is performed in accordance with the protocol provided from a customer (for example, a business entity that performs the test after the pre-processing). The protocol includes processing conditions and the like in addition to the processing procedure.

### [Plate ID Reading Step]

The plate ID reading step S001 is a step of reading, by reading means 13, an identification code (hereinafter referred to as “plate ID”) indicated on a plate 18 serving as a specimen expelling destination. The plate ID is a unique identification code applied to each plate, and is formed of a barcode, a QR code (trademark, the same holds true in the following), or the like. The indication referred to here includes, in addition to indication performed by affixing a sticker having the plate ID printed thereon, for example, indication performed by directly printing the plate ID onto the tube X.

In the plate ID reading step S001, a plate ID that has been read (read plate ID) is recorded in the PC 40 as the execution information. The read plate ID is one obtained by reading the plate ID indicated on the plate 18, and thus matches this plate ID.

The plate ID reading step S001 is a step that is manually performed at a stage before the operation is started by the robot 30. In this embodiment, after the plate ID reading step S001, the taking-out step S002 and subsequent steps of FIG. 1 are started.

### [Taking-Out Step]

The taking-out step S002 is a step of taking out, by a hand (hereinafter referred to as “first hand”) 31a of a first robot arm (hereinafter referred to as “first arm”) 31, a tube X having a specimen stored therein. In this step, one tube X stored in a tube rack 11 is grasped by the first hand 31a of the first arm 31.

### [Specimen ID Reading Step]

The specimen ID reading step S003 is a step of reading, by the reading means 13, specimen identification information (hereinafter referred to as “specimen ID”) for identifying the specimen indicated on the tube X. The specimen ID is a unique ID applied to each specimen, and is formed of a barcode, a QR code, a code obtained by combining letters, numbers, and the like representing the specimen ID (hereinafter referred to as “identification code”), and the like. Specifically, there are cases of only a barcode, only a QR code, a combination of an identification code and a barcode, a combination of an identification code and a QR code, and the like. The indication referred to here includes, in addition to indication performed by affixing a sticker having the specimen ID printed thereon, for example, indication performed by directly printing the specimen ID onto the tube X.

In this step, the first arm 31 moves the tube X to a reading position of the reading means 13, and the reading means 13 reads the specimen ID indicated on this tube X. The reading of the specimen ID can be performed under a state in which the tube X is stopped and under a state in which the tube X is rotated in a forward direction or a backward direction. The reading performed under the state in which the tube X is rotated in the forward direction or the backward direction enables correct and reliable reading also in a case in which the specimen ID is indicated obliquely with respect to a longitudinal axis of the tube X. In the reading of the specimen ID, the tube X can be continuously rotated or divisionally and intermittently rotated a plurality of times. Further, at the time of reading the specimen ID, the tube X may be vertically moved so as to cope with a vertical error of an affixing position of the sticker of the tube X.

In the specimen ID reading step S003, when the reading has succeeded, the specimen ID read by the reading means 13 (hereinafter referred to as “read specimen ID”) is recorded in the PC 40 as the execution information. When the reading has failed, the fact that this tube X has been moved to a saving box is recorded in the PC 40 as the execution information. The read specimen ID is one obtained by reading the specimen ID indicated on the tube X, and hence matches this specimen ID.

### [Specimen ID Image Acquiring Step]

The specimen ID image acquiring step S004 is a step of acquiring, by image acquiring means 14, an image of the specimen ID indicated on the tube X. In this step, the first arm 31 moves the tube X to an image acquiring position of the image acquiring means 14, and the image acquiring means 14 acquires the image of the specimen ID indicated on this tube X.

In some cases, the specimen ID indicated on the tube X is indicated obliquely with respect to the longitudinal axis of the tube X, indicated left and right oppositely, indicated upside down, and the like. Thus, it is preferred that the image be acquired a plurality of times while continuously or intermittently rotating the tube X in the forward direction or the backward direction. The traceability (trackability) can be ensured by the image obtained by acquiring an image (hereinafter referred to as “specimen ID image”). Further, the specimen ID image can also be used for checking the read specimen ID read by the reading means 13.

In the specimen ID image acquiring step S004, the specimen ID image obtained by acquiring an image by the image acquiring means 14 is recorded in the PC 40 as the execution information.

### [Uncapping Step]

The uncapping step S005 is a step of removing (opening) a cap Y of the tube X. In this step, the first arm 31 arranges the tube X at a predetermined position of the tube vice 16, and the first hand 31a of the first arm 31 removes the cap Y of the tube X clamped by a clamping portion 16a of the tube vice 16.

In this embodiment, the cap Y of the tube X clamped by the tube vice 16 is grasped by the first hand 31a of the first arm 31, and this first hand 31a is rotated so that the cap Y of the tube X is removed.

After the operation of uncapping performed by the first arm 31 is finished, whether or not the uncapping has succeeded is determined based on a determination condition (uncapping determination condition) set in advance based on the protocol. Whether or not the uncapping has succeeded can be determined by various methods, but, in this embodiment, whether or not the cap Y is grasped is determined based on pressures and positions of two claws of the first hand 31a.

That is, the two claws are separated by a diameter of the cap Y or more when the cap Y is grasped by the first hand 31a, while the distance between the two claws is less than the diameter of the cap Y when the cap Y is not grasped. Accordingly, measurement of the positions (distance) of both the claws allows whether or not the cap Y is grasped (whether or not the cap Y is opened) to be determined.

Whether or not the uncapping has succeeded can also be determined by other methods. For example, the determination can be made based on a load measurement of a motor (not shown) built into a wrist. When the cap Y is not removed from the tube X clamped by the tube vice 16, a predetermined amount of load or more is applied to the wrist of the first hand 31a when the cap Y is rotated, and hence measurement of this load allows whether or not the uncapping has succeeded to be determined. This method can be adopted in place of the method of measuring the pressure and the position of the first hand 31a (two claws thereof), or in addition to this method.

In the uncapping step S005, a determination result (uncapping determination result) of whether or not the uncapping has succeeded is recorded in the PC 40 as the execution information. Further, in this embodiment, the robot 30 suspends its operation when it is determined that the uncapping has failed. In this embodiment, notification is given by sound, light, or the like when the robot 30 suspends its operation.

### [Tip Mounting Step]

The tip mounting step S006 is a step of mounting a tip Z to a distal end of a pipette P grasped by a hand (hereinafter referred to as “second hand”) 32a of a second robot arm (hereinafter referred to as “second arm”) 32. In this step, the second arm 32 lowers the pipette P which has been moved to a position above a tip rack 19, toward a predetermined tip Z so that the tip Z is fitted and mounted to the distal end of the pipette P.

In this step, the second arm 32 moves the tip Z mounted on the distal end of the pipette P to the image acquiring position of the image acquiring means 14, and the image acquiring means 14 acquires an image of this tip Z. The image can be acquired under a stationary state and under a state in which the tip Z is rotated in the forward direction or the backward direction. The traceability (trackability) can be ensured by the acquired image taken in this step (hereinafter referred to as “mounted tip image”).

In the tip mounting step S006, the mounted tip image obtained by acquiring an image by the image acquiring means 14 is recorded in the PC 40 as the execution information.

### [Mounted Tip Checking Step]

The mounted tip checking step S007 is a step of checking whether or not the tip Z is mounted on the distal end of the pipette P based on a criteria (tip mounting criteria) set in advance based on the protocol. In this step, whether or not the inside of the mounted tip Z is vacant is also checked. Whether or not the mounting of the tip Z has succeeded can be determined by various methods, but, in this embodiment, whether or not the tip Z is mounted is determined based on the mounted tip image.

This determination is performed by a processor 41 of the PC 40. From the mounted tip image, it is determined that the mounting has succeeded when the tip Z is mounted on the distal end of the pipette P, and it is determined that the mounting has failed when the tip Z is not mounted on the distal end of the pipette P.

In the mounted tip checking step S007, a determination result (tip mounting determination result) of whether or not the mounting of the tip has succeeded is recorded in the PC 40 as the execution information. Further, in this embodiment, the robot 30 suspends its operation when it is determined that the tip mounting has failed. Similarly to other steps, also in this step, notification is given by sound, light, or the like when the robot 30 suspends its operation.

### [Drawing Step]

The drawing step S008 is a step of drawing the specimen in the tube X clamped by the tube vice 16 into the tip Z mounted on the distal end of the pipette P. This step is performed through cooperation of the first arm 31 and the second arm 32.

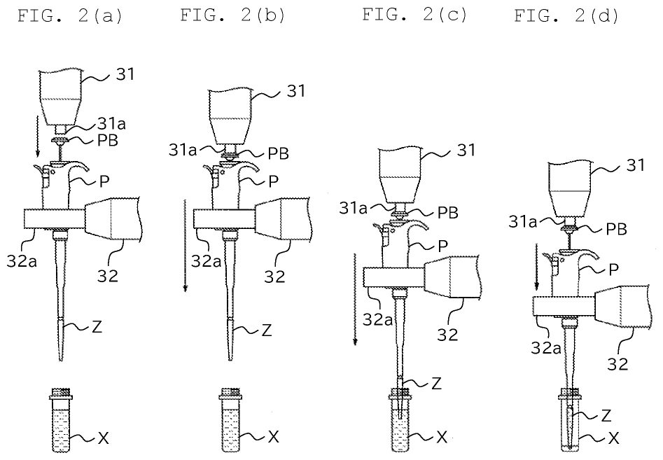

Specifically, as illustrated in FIG. 2 (a) to FIG. 2 (d), a push button PB of the pipette P held by the second hand 32a of the second arm 32 is depressed by the first hand 31a of the first arm 31, and the tip Z mounted on the pipette P is inserted into the tube X under this state. After that, the depressing of the push button PB of the pipette P is released so that the specimen in the tube X is drawn into the tip Z. When the tip Z is inserted into the specimen in the tube X, the distal end of the tip Z is positioned near a liquid surface of the specimen so that the distal end of the tip Z is prevented from being brought into contact with a bottom of the tube X.

In this embodiment, a lowering speed of the first arm depressing the push button PB of the pipette P is adjusted to be slower than a lowering speed of the second arm 32 holding the pipette P. In this manner, the depressing of the push button PB can be released so that the specimen is drawn into the tip.

In this embodiment, the lowering speed of the second arm 32 (in other words, the lowering speed of the pipette P held by the second arm 32) is adjusted so as to be the same as or faster than a speed in which the liquid surface of the specimen is lowered (specimen reducing speed). In this manner, at the time of drawing the specimen, the distal end of the tip Z is prevented from coming above the liquid surface of the specimen in the tube X.

At the time of drawing the specimen, the liquid surface of the specimen is gradually lowered along with the drawing of the specimen. Thus, the distal end of the tip Z comes above the liquid surface of the specimen in the tube X depending on the lowering speed of the second arm 32, and there is a fear of mixture of air. When the lowering speed of the second arm 32 is adjusted as described above as in this embodiment, the mixture of air at the time of drawing the specimen can be avoided.

In this step, the second arm 32 moves the tip Z after specimen drawing, which is mounted to the distal end of the pipette P, to the image acquiring position of the image acquiring means 14, and the image acquiring means 14 acquires an image of this tip Z. The image can be acquired under a stationary state and under a state in which the tip Z is rotated in the forward direction or the backward direction. The traceability (trackability) can be ensured by the acquired image taken in this step (hereinafter referred to as “tip image after drawing”).

In the drawing step S008, the tip image after drawing obtained by acquiring an image by the image acquiring means 14 is recorded in the PC 40 as the execution information.

### [Drawn Amount Checking Step]

The drawn amount checking step S009 is a step of checking a drawn amount of the specimen. In this step, from the tip image after drawing, it is determined whether or not a specified amount of specimen is drawn into the tip Z mounted on the distal end of the pipette P. The specified amount referred to here is an amount freely set in accordance with the characteristics of the specimen and the specification of the analysis test, and is designated as a part of the protocol. Further, in some cases, a manufacturer, a model number, a size, and the like of the tip are included in a part of the protocol.

An object whose image is to be acquired in this step may be the whole or a part of the tip Z. In a case of acquiring an image of a part of the tip Z, for example, the image can be acquired so that a drawn specimen part and an air part on the upper side thereof are included in the image. The tip image after drawing includes the entire tip Z, the specimen drawn into the tip Z, and air on the upper side of the drawn specimen.

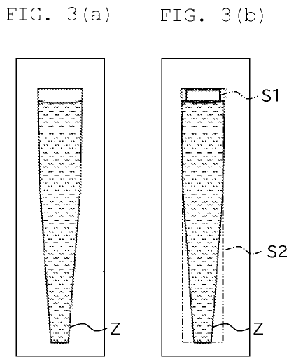

In this embodiment, the tip image after drawing is subjected to image processing so that whether or not a specified amount of specimen is drawn is determined. Specifically, as illustrated in FIG. 3 (a) and FIG. 3(b), it is determined that a specified amount of specimen is drawn when a size, an area, a configuration, a region serving as a target, or a value obtained by quantifying each of those items of a figure in a plane or a curved surface of an air part S1 (region surrounded by the dashed-dotted line of FIG. 3 (b)) in the tip Z of acquired image data (FIG. 3 (a)) satisfies a criteria (hereinafter referred to as “drawn amount criteria”) set in advance based on the protocol, and it is determined that a specified amount of specimen is not drawn when the above-mentioned item does not satisfy the criteria.

In this embodiment, the size, the area, the configuration, the region serving as a target, or the value obtained by quantifying each of those items of the figure in the plane or the curved surface of the air part S1 in the tip Z is used as the criteria, but a size, an area, a configuration, a region serving as a target, or a value obtained by quantifying each of those items of a figure in a plane or a curved surface of a specimen part S2 (region surrounded by the dashed-two dotted line of FIG. 3(b)) in the tip Z can also be used as the criteria. Also in this case, it can be determined that a specified amount of specimen is drawn when the size, the area, the configuration, the region serving as a target, or the value obtained by quantifying each of those items of the figure in the plane or the curved surface of the specimen part S2 in the tip Z whose image has been acquired satisfies a drawn amount criteria set in advance based on the protocol, and it can be determined that a specified amount of specimen is not drawn when the above-mentioned item does not satisfy the criteria.

Whether or not a specified amount of specimen is drawn can also be determined with reference to, other than the size, the area, the configuration, the region serving as a target, or the value obtained by quantifying each of those items of the figure in the plane or the curved surface of the air part S1 or the specimen part S2, a distance from an upper end to a lower end of the air part S1, a distance from an upper end to a lower end of the specimen part, an area ratio between the air part and the specimen part, a ratio in distance from the upper end to the lower end between both of the air part S1 and the specimen part S2, and the like.

In the drawn amount checking step S009, a determination result (drawn amount determination result) of whether or not a specified amount of specimen is drawn into the tip Z is recorded in the PC 40 as the execution information. The drawn amount determination result referred to here may include, in addition to whether or not the drawn amount falls within a range of the specified amount, a specific numerical value of the drawn amount and the like.

Further, in this embodiment, the robot 30 suspends its operation when it is determined that a specified amount of specimen is not drawn. Similarly to other steps, also in this step, notification is given by sound, light, or the like when the robot 30 suspends its operation.

### [Expelling Step]

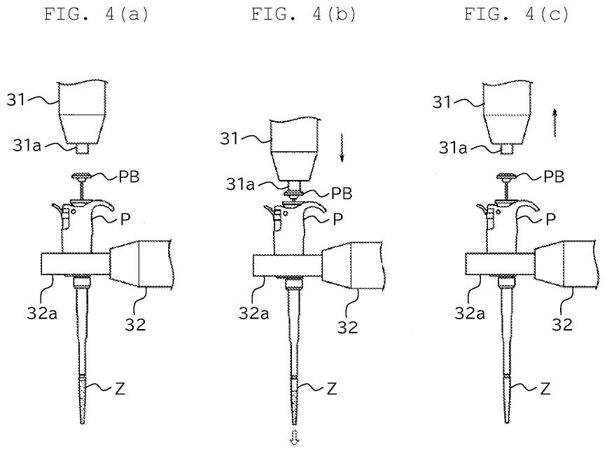

The expelling step S010 is a step of expelling the drawn specimen to a plate hole 18a. As illustrated in FIG. 4 (a) to FIG. 4 (c), this step is performed through cooperation of the first arm 31 and the second arm 32. Specifically, the second arm 32 moves the tip Z on the distal end of the pipette P to a predetermined position of the plate 18. Then, the first hand 31a depresses the push button PB of the pipette P at this position so that the specimen in the tip Z is expelled to the plate hole 18a.

In the expelling step S010, a plate ID of an expelling destination (hereinafter referred to as “expelling destination plate ID”) and information on a plate hole in the expelling destination plate ID (expelling destination plate hole) are recorded in the PC 40 as the execution information.

The expelling destination plate hole is identified by XYZ coordinates (for example, three axes of XYZ coordinates or two axes of an X coordinate and a Y coordinate) in the work space coordinates set through use of the robot 30 as a reference. The plate ID and the expelling destination plate hole identified by the X coordinate and the Y coordinate referred to here are recorded in the PC 40 as expelling destination identifying information for identifying the expelling destination. As the expelling destination identifying information, information of a combination of a reference symbol of one of A to H allocated to a column (X-axis) of the plate 18 and a number of one of 1 to 12 allocated to a row (Y-axis) of the plate 18 can also be used.

### [Expelled Amount Checking Step]

The expelled amount checking step S011 is a step of checking whether or not a specified amount of specimen is expelled from the tip Z. In this step, the second arm 32 moves the tip Z mounted on the distal end of the pipette P to the image acquiring position of the image acquiring means 14, and the image acquiring means 14 acquires an image of this tip Z. From the acquired tip image (hereinafter referred to as “tip image after expelling”), it is determined, by the processor 41 of the PC 40, whether or not a specified amount of specimen is expelled from the tip z.

Similarly to the drawn amount checking step S009, an object whose image is to be acquired in this step may be the whole or a part of the tip Z. In a case of acquiring an image of a part of the tip Z, for example, the image can be acquired so that a specimen remaining in the tip Z after the expelling (hereinafter referred to as “remaining specimen”) and an air part on an upper side of the remaining specimen part are included in the image. In this case, the tip image after expelling includes the entire tip z, the remaining specimen, and air on the upper side of the remaining specimen part.

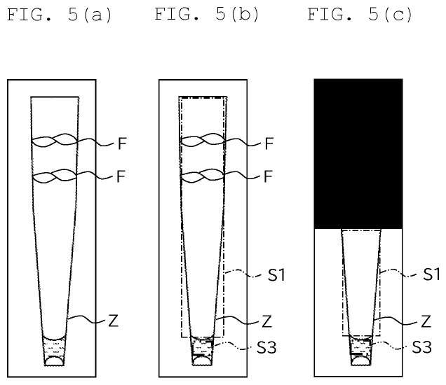

In this embodiment, similarly to the drawn amount checking step S009, an image of the tip Z acquired by the image acquiring means 14 is subjected to image processing so that whether or not a specified amount of specimen is expelled is determined. Specifically, as illustrated in FIG. 5 (a) and FIG. 5(b), it is determined as normal when a size, an area, a configuration, a region serving as a target, or a value obtained by quantifying each of those items of a figure in a plane or a curved surface of an air part S1 (region surrounded by the dashed-dotted line of FIG. 5 (b)) of the acquired tip image after expelling satisfies a criteria (hereinafter referred to as “expelled amount criteria”) set in advance based on the protocol (when the above-mentioned item falls within a range of a threshold value), and it is determined as an error when the above-mentioned item does not satisfy the criteria (threshold value) (when the above-mentioned item is outside of the range of the threshold value). Similarly to the drawn amount checking step S009, this determination is performed by the processor 41 of the PC 40.

Further, in performing the determination, even when the expelled amount is appropriate, in some cases, a film or air bubbles (hereinafter referred to as “film or the like”) F caused in the tip Z are erroneously recognized as a specimen so that it is determined that a specified amount of specimen is not expelled. The film or the like F is a phenomenon that hinders the determination of the expelled amount. In some cases, the phenomenon is caused depending on, for example, characteristics and a temperature of a buffer solution, a shape and a size of the tip Z, and the like.

When a phenomenon that hinders the determination of the expelled amount as the film or the like F has occurred, processing is performed so that the determination is prevented from being hindered by this phenomenon. As the processing method, for example, there is a method in which, as illustrated in FIG. 5 (c), the tip image after expelling is copied on the PC 40, and a part of the copied tip image after expelling (for example, a tip upper portion at which the film or the like F is liable to occur) is hidden (blacked out) so that a determination target region is narrowed. In this case, a size, an area, a configuration, a region serving as a target, or a value obtained by quantifying each of those items of a figure in a plane or a curved surface of the air part S1 or a remaining specimen part S3 under a state in which the determination target region is narrowed may be calculated so that whether or not a specified amount of specimen is expelled is determined from this calculated value.

In FIG. 5 (c), a part in which the phenomenon of the film or the like F has occurred (hereinafter referred to as “phenomenon occurring part”) is blacked out and hidden so that the determination target region is restricted. However, the determination target region can also be restricted by a method other than blacking out. For example, it is conceivable to cut (remove) a part including the phenomenon occurring part on the image so that the determination target region is restricted, and determine whether or not a specified amount of specimen is expelled based on an evidence after cutting.

As the method of hiding the phenomenon occurring part, for example, there is a method in which a hiding range is set in advance so that this range of the evidence is uniformly hidden. For example, a hiding range of the evidence can be set in advance as a range of 10% of the upper portion of the evidence or a range of 50 mm from the top of the evidence, and this range on the evidence can be hidden. The hiding range can also be set by a method as 50 mm from the top of the evidence. Those numerical values are merely examples, and the hiding range can also be set with other numerical values. Further, a reference of the hiding position is not limited to from the top of the evidence. For example, an upper end of the tip in the evidence can be set as a reference, and the hiding position can be set as several percents or several millimeters from the upper end of the tip in the evidence.

The phenomenon occurring part can also be hidden by changing a hiding position or range for each evidence based on a certain reference. For example, when a specific phenomenon (for example, a line appearing in the tip Z on the evidence) is observed on the evidence, the hiding position or range can be changed for each evidence based on this phenomenon. Further, the hiding position or range can also be changed for each evidence based on, for example, characteristics and performance of the specimen or the buffer solution, mechanical wear of the pipette P or the tip Z, work environment (temperature, humidity, atmospheric pressure, and the like), and the like.

The phenomenon occurring part can also be hidden by, for example, a method in which a mounting angle is detected from the image acquired when the tip Z is mounted, and a change of a discharge amount is estimated from this angle so that the hiding place (for example, a position, a range, or the like) is changed in accordance therewith, a method in which a hiding region is moved downward every predetermined time periods (for example, several seconds), and the like. For example, the former method may be an effective method as a countermeasure to a case in which a mechanical wear has occurred, such as a case in which a tightness of a coupled part C between the pipette P and the tip Z is loosened, and the latter method may be an effective method as a countermeasure to a case in which it is required to consider a wall surface adhering residual amount in the tip Z due to the viscosity of the specimen. Description is given here of the case in which a part of the evidence is hidden, but similar methods can be adopted even when a part of the evidence is cut.

When the determination target region is restricted by blacking out or removing the phenomenon occurring part or by other methods, it is preferred that both of an evidence before restriction (before performing blacking-out processing or cutting processing) (tip image after expelling) and an evidence after restriction (after performing blacking-out processing or cutting processing) (tip image after processing) be kept as records. Further, the evidence before restriction and the evidence after restriction can be displayed side by side on a monitor 21. Both of the evidences may also be displayed individually without being arranged side by side.

When both of the evidence before restriction (for example, raw image data such as a still image or a moving image) and the evidence after restriction are kept as records, the state of the phenomenon occurring part can be verified afterwards. In this embodiment, the evidence before restriction and the evidence after restriction are recorded in recording means (storage 43) in association with each other.

Here, a case in which a photograph (still image) acquired by the image acquiring means 14 is used as the evidence (hereinafter referred to as “acquired-image evidence”) is described as an example, but a moving image acquired by the image acquiring means 14 can also be used as the acquired-image evidence. Also in other steps of this application, an image is acquired by the image acquiring means 14, but the acquired image may be a still image or a moving image in any of the cases. The still image or the moving image obtained by acquiring an image can be used as the acquired-image evidence.

The method of the image processing to be performed when a phenomenon that hinders the determination has occurred may be a method other than hiding or removing a part, and can also be methods such as image correction, image conversion, image editing, feature extraction, image recognition, three-dimensionalization, quantification, and the like.

The image correction referred to here includes correction of contrast, brightness, color, and the like. The image conversion referred to here includes conversion of a color image into a monochrome image, and the like. The image editing referred to here includes noise removal, edge enhancement, enlargement, reduction, and the like. The image feature extraction referred to here includes measurement of an area or circularity, and the like. The image recognition referred to here includes identification of a target, and the like. The three-dimensionalization referred to here includes three-dimensionalization processing of a two-dimensional image, and the like. The quantification referred to here includes conversion of an image into numerical values, and the like. Those types of processing are all methods for performing processing on a digital image. For example, in the case of image recognition, the phenomenon occurring part can be identified for each evidence so that this phenomenon occurring part is hidden or removed.

Whether or not a specified amount of specimen is expelled can also be determined through use of, as the criteria, a size, an area, a configuration, a region serving as a target, or a value obtained by quantifying each of those items of a figure in a plane or a curved surface of the remaining specimen part S3 in the tip Z after expelling. Also in this case, it can be determined as normal when the size, the area, the configuration, the region serving as a target, or the value obtained by quantifying each of those items of the figure in the plane or the curved surface of the remaining specimen part S3 in the tip Z whose image is acquired satisfies a criteria (threshold value) set in advance based on the protocol (when the above-mentioned item falls within the range of the threshold value), and it can be determined as an error when the above-mentioned item does not satisfy the criteria (threshold value) (when the above-mentioned item is outside of the range of the threshold value).

Whether or not a specified amount of specimen is expelled can also be determined with reference to, other than the size, the area, the configuration, the region serving as a target, or the value obtained by quantifying each of those items of the figure in the plane or the curved surface of the air part S1 or the size, the area, the configuration, the region serving as a target, or the value obtained by quantifying each of those items of the figure in the plane or the curved surface of the remaining specimen part S3, a distance from an upper end to a lower end of the air part, a distance from an upper end to a lower end of the remaining specimen part, an area ratio between the air part and the remaining specimen part, a ratio in distance from the upper end to the lower end between both of the air part and the remaining specimen part, and the like.

In the expelled amount checking step S011, in addition to the tip image after expelling obtained by acquiring an image by the image acquiring means 14, the tip image after processing and a determination result (hereinafter referred to as “expelled amount determination result”) of whether or not a specified amount of specimen is expelled are recorded in the PC 40 as the execution information. The expelled amount determination result referred to here may include, in addition to whether or not the expelled amount falls within a range of the specified amount, a specific numerical value of the expelled amount and the like.

Further, in this embodiment, the robot 30 suspends its operation when it is determined that the expelled amount does not satisfy the criteria (hereinafter referred to as “expelled amount criteria”) set in advance based on the protocol. Similarly to other steps, also in this step, notification is given by sound, light, or the like when the robot 30 suspends its operation.

### [Tip Removing Step]

The tip removing step S012 is a step of removing the tip Z mounted on the distal end of the pipette P. In this step, the second arm 32 hooks the coupled part C between the pipette P and the tip Z to a peripheral edge of a locking recessed portion 20d of a tip remover 20. The pipette P is raised under this state so that the tip Z is removed from the pipette P.

### [Capping Step]

The capping step S013 is a step of capping (closing) the tube X clamped by the tube vice 16. In this step, the first hand 31a of the first arm 31 takes out a new cap Y stored in a cap rack 12, and this cap Y is mounted on (used for capping of) the tube X clamped by the tube vice 16. In this embodiment, the first hand 31a grasping the cap Y is rotated so that the tube X is capped.

### [Capping Checking Step]

The capping checking step $014 is a step of checking whether or not the tube X is capped after the capping step S013 is finished (whether or not the cap Y is mounted on the tube X). In this step, whether or not the capping has succeeded is determined based on a criteria (capping criteria) set in advance based on the protocol. Whether or not the capping is performed can be checked by, for example, the following two methods.

The first method is a method of determining whether or not a load applied to the first hand 31a when the cap Y of the tube X is picked up by the first hand 31a of the first arm 31 satisfies the capping criteria set in advance based on the protocol. When the determination is made by this method, it is determined that the capping has succeeded when the tube X is also raised together with the cap Y (when the capping criteria is satisfied), and it is determined that the capping has failed because the capping is insufficient (lack of tightness) when the tube X is not raised but only the cap Y is raised (when the capping criteria is not satisfied).

When the tube X after capping is returned back to the tube rack 11, the tube X is raised by the first hand 31a of the first arm 31. The determination by this method can be performed at the time of the operation of picking up the cap Y when the tube X after capping is returned back to the tube rack 11. Thus, another step is not required, and hence the determination of capping can be efficiently performed.

The second method is a method of making the determination from an image acquired by the image acquiring means 14 (hereinafter referred to as “tube image after capping”). When the determination is made by this method, the first hand 31a of the first arm 31 picks up the cap Y of the tube X to move the tube X to the image acquiring position of the image acquiring means 14. After the tube X is moved to the image acquiring position by the first arm 31, the image acquiring means 14 acquires an image of the tube X. It is determined that the capping has succeeded when the tube image after capping includes the tube X together with the cap Y, and it is determined that the capping has failed when the capping tube image includes only the cap Y and does not include the tube X. Whether or not the capping has succeeded can also be determined by other methods.

Whether or not the cap Y is mounted on the tube X, in other words, whether or not the tube X is tightly closed is checked in order to prevent negative effects of contaminations and denaturation of the specimen from occurring due to the lack of tightness of the tube X. In a case in which the cap Y is not closed, a residue specimen may scatter when the tube X falls or tilts, which may cause contaminations. Further, carbon dioxide in the air may be dissolved so as to change pH, and the residue specimen may be denatured (nucleic acid in a cell may be denatured).

In order to prevent those troubles, in this embodiment, whether or not the cap Y is mounted on the tube X is checked, and the robot 30 suspends its operation when the capping has failed. In this manner, the negative effects caused because the cap Y is not closed can be avoided in advance.

In the capping checking step S014, in addition to the tube image after capping obtained by acquiring an image by the image acquiring means 14, a determination result (capping determination result) of whether or not the capping has succeeded is recorded in the PC 40 as the execution information.

Further, in this embodiment, the robot 30 suspends its operation when it is determined that the capping has failed. Similarly to other steps, also in this step, notification is given by sound, light, or the like when the robot 30 suspends its operation.

### [Storing Step]

The storing step S015 is a step of taking out the capped tube X from the tube vice 16 and returning the capped tube X back to a storing recessed portion 11a of the tube rack 11. In this step, the first hand 31a of the first arm 31 takes out the capped tube X from the tube vice 16, and the taken-out tube X is returned back to the original storing recessed portion 11a of the tube rack 11.

### [Other Steps]

Although omitted in the flow chart of FIG. 1, in this embodiment, after the reading in the specimen ID reading step S003, whether or not the read specimen ID overlaps an already read specimen ID is determined. As a result of the determination, when it is determined that the specimen ID is overlapping, the tube X indicating this specimen ID is stored into the saving box (not shown) through an operation of the robot 30. In this case, the specimen ID indicated on this tube X is recorded in the PC 40.

Further, in this embodiment, it is determined whether or not the specimen ID is omitted from a specimen ID list registered in advance. As a result of the determination, when it is determined that the specimen ID is omitted from the specimen ID list, the tube X indicating this specimen ID is stored into the saving box (not shown) through an operation of the robot 30. Also in this case, the specimen ID indicated on this tube X is recorded in the PC 40.

All of the pieces of execution information obtained in the respective steps of the pre-processing are recorded in the storage (recording means) 43 of the PC 40 in association with the specimen ID (read specimen ID). That is, each piece of execution information is recorded for each specimen ID. For example, in a case of a specimen given with a specimen ID of “xxxxx,” all pieces of execution information related to this specimen ID of “xxxxx” are recorded in association with the specimen ID of “xxxxx.”

In this manner, for example, as for the specimen ID of “xxx xx,” from its expelled amount determination result, it is checked whether or not the expelled amount satisfies the criteria, and this result is compared with the tip image after expelling which is associated with this specimen ID of “xxxxx” so that whether or not the expelled amount determination result of this specimen ID of “xxxxx” is proper can be checked. As described above, when two or more pieces of execution information are recorded with respect to one round of processing, comparison between the protocol and the execution result (execution information) and comparison between execution results (pieces of execution information) are allowed.

In each step of the embodiment, whether or not the uncapping has succeeded, whether or not the tip mounting has succeeded, whether or not the drawn amount falls within the range of the specified amount, whether or not the expelled amount falls within the range of the specified amount, whether or not the capping has succeeded, and the like are determined by the processor 41 of the PC 40, but each criteria serving as a reference of success/failure is set as appropriate depending on the specification of the test using a specimen and an instrument to be used (pipette P, tip Z, tube X, cap Y, and the like). Each criteria is set in advance in accordance with a designation from a customer side, or, in some cases, a position and a pressure of the first arm 31, the second arm 32, the first hand 31a, the second hand 32a, and the like, a method of the image processing, and the like are created by a provider side of the pre-processing executing system.

In the embodiment, a case in which steps from the taking-out step S002 to the reading step S015 are performed in a sequence is given as an example, but each of the steps can be carried out in units of each step or in units of a plurality of steps. Further, not all of the steps are essentially required steps, and an unrequired step can be omitted as appropriate. The embodiment is merely an example, and the steps can be exchanged, modified, added, and the like as appropriate without departing from the gist thereof.

### [Overview of System for Executing Pre-Processing]

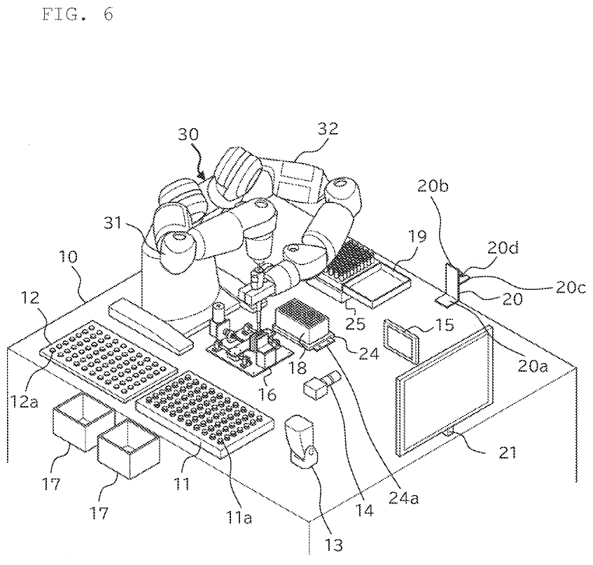

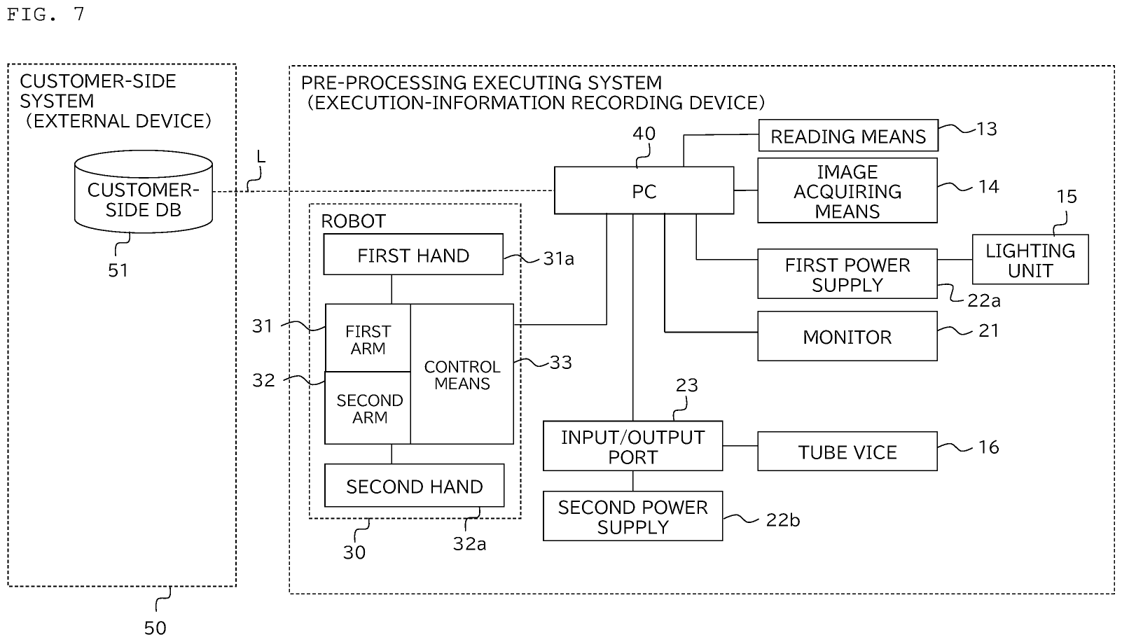

Next, an example of a pre-processing executing system for carrying out each of the steps is described with reference to the drawings. This pre-processing executing system has a function of automatically recording the execution information at the time of executing each step, and a part or the whole of the pre-processing executing system functions as an execution-information recording device of the present invention. As an example, a system illustrated in FIG. 6 and FIG. 7 includes a setting stand 10, the tube rack 11, the cap rack 12, the reading means 13, the image acquiring means 14, a lighting unit 15, the tube vice 16, cap collection boxes 17, the plate 18, the tip rack 19, the tip remover 20, the monitor 21, an input/output port 23, the robot 30, the PC 40, and the like.

The setting stand 10 is a stand on which various devices such as the tube rack 11, the cap rack 12, the reading means 13, the image acquiring means 14, the lighting unit 15, the tube vice 16, the plate 18, the tip rack 19, the tip remover 20, the monitor 21, the robot 30, and the PC 40 are set. A stainless stand or the like can be used as the setting stand 10.

In this embodiment, various devices forming the system are set on one setting stand 10. Thus, as compared to a related-art system formed by combining devices modularized by functions (steps), there is an advantage in that a setting space can be saved.

The tube rack 11 is a container for storing the tube X storing the specimen. In this embodiment, a container including ninety-six (eight vertically and twelve horizontally) bottomed storing recessed portions 11a is used as the tube rack 11. The tube rack 11 has a height that allows at least the cap Y of the tube X to project upward from an upper surface of the tube rack 11 when the tube X is stored in the storing recessed portion 11a.

The cap rack 12 is a container for storing new caps Y to be mounted to the tube X after drawing of the specimen. In this embodiment, a container including ninety-six (eight vertically and twelve horizontally) bottomed cap storing portions 12a is used as the cap rack 12. The cap rack 12 has a height that allows at least the cap Y to project upward from an upper surface of the cap rack 12 when the cap Y is stored in the cap storing portion 12a.

For example, a removable container which can be put into an irradiation-type sterilization device (ultraviolet sterilization device having an ultraviolet lamp installed thereon) while all or a part of the caps Y are loaded thereon can be used as the cap rack 12. In a case in which a removable container which can be put into the irradiation-type sterilization device is used, when a gene of a person (for example, a worker) erroneously adheres to the cap Y, this gene can be disrupted so that contaminations can be prevented.

The reading means 13 is a device for reading the specimen ID indicated on the tube X. Various readers, such as a barcode reader and a QR code reader, can be used as the reading means 13. In this embodiment, a stationary barcode reader capable of reading a one-dimensional code and a two-dimensional code is used as the reading means 13. Other devices can also be used as the reading means 13.

In this embodiment, when the specimen ID indicated on the tube X arrives and falls within a reading range of the reading means 13, this specimen ID is read by this reading means 13. The read plate ID that has been read is transmitted to the PC 40 to be recorded in the storage 43.

The image acquiring means 14 is a device for acquiring images of the tip Z and the specimen ID indicated on the tube X. A camera including a variable-focal length lens or the like can be used as the image acquiring means 14. In this embodiment, a case in which one camera is used is given as an example, but the image acquiring means 14 can also be formed of a plurality of cameras. Further, in addition to a device for acquiring a still image, a device for acquiring a moving image, a device for acquiring both of a still image and a moving image, and the like can be used as the image acquiring means 14.

The lighting unit 15 is a device for illuminating the tube X (specimen ID) or the tip Z serving as an image acquiring target of the image acquiring means 14. A first power supply 22a is connected to the lighting unit 15, and the lighting unit 15 operates with power supplied from this first power supply 22a. In this embodiment, a highly-directional white lighting is used as the lighting unit 15. This lighting unit 15 has a thin-plate shape, and is mounted to the setting stand 10 under a state in which the lighting unit 15 stands vertically upright. Other devices can also be used as the lighting unit 15.

In this embodiment, when the tube X is moved to the image acquiring position by the first arm 31 to be described later, and when the tip Z is moved to the image acquiring position by the second arm 32 to be described later, this tube X or tip Z is illuminated by the lighting unit 15, and an image thereof is acquired by the image acquiring means 14. The acquired image (specimen ID image, mounted tip image, tip image after drawing, tip image after expelling, tip image after capping, and the like) is transmitted to the PC 40 to be recorded in the storage 43.

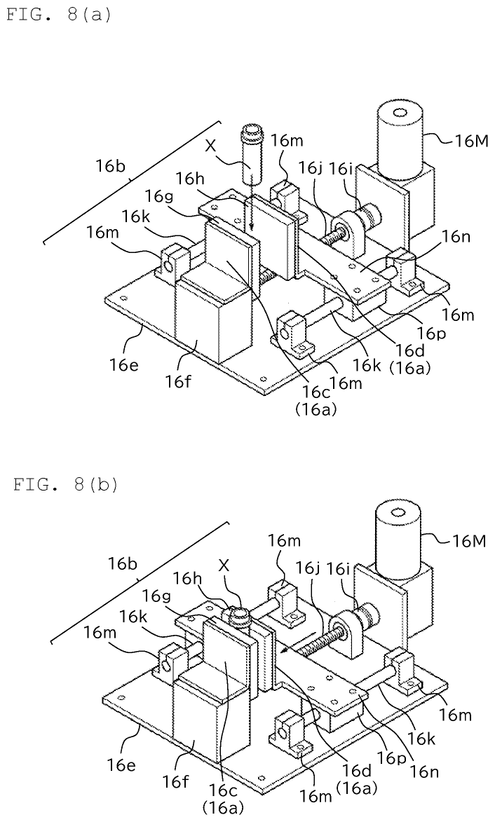

The tube vice 16 is a device for clamping the tube X. As illustrated in FIG. 8 (a) and FIG. 8 (b), the tube vice 16 in this embodiment includes a clamping portion 16a for clamping the tube X, a drive mechanism 16b for opening and closing the clamping portion 16a, and a drive source (motor) 16M for operating the drive mechanism 16b.

The clamping portion 16a in this embodiment includes two clamping pieces 16c and 16d arranged so as to be opposed to each other. One clamping piece (hereinafter referred to as “fixed clamping piece”) 16c is formed of an L-shaped plate arranged on a clamping piece seat 16f provided on a base plate 16e, and the other clamping piece (hereinafter referred to as “movable clamping piece”) 16d is formed of a part (rising part) of a movable T-shaped plate 16n which is to be moved by the drive mechanism 16b. Cushioning members 16g and 16h are provided on opposing surfaces of both the clamping pieces 16c and 16d, respectively.

The drive mechanism 16b includes a coupling 16i, a ball screw 16j, and a ball nut (not shown). The motor 16M is coupled to the ball screw 16j through intermediation of the coupling 16i, and the ball nut (not shown) is provided to the ball screw 16j. On each of both outer sides of the ball screw 16j, one linear guide 16k is arranged in parallel to the ball screw 16j. Both longitudinal end sides of each linear guide 16k are supported by guide supporters 16m.

The T-shaped plate 16n is fixed to the ball nut, and the movable clamping piece 16d is configured to move in a direction of approaching or separating away from the fixed clamping piece 16c in association with the motion of the ball nut. One guide block 16p having a through hole is provided on each of both longitudinal end sides of a back surface of the T-shaped plate 16n, and the linear guide 16k is inserted through the through hole. In this manner, at the time of the operation of moving the T-shaped plate 16n, lateral shifting of the T-shaped plate 16n is prevented.

The cap collection box 17 is a container for collecting the cap Y removed from the tube X. An existing resin container or the like can be used as the cap collection box 17. The cap collection box 17 can be set at any position at which the first arm 31 can reach the cap collection box 17 (in this embodiment, a lateral side of the setting stand 10).

The plate 18 is a container used for transferring the drawn specimen. Although not shown, each plate 18 has a plate ID, such as a barcode or a QR code, indicated thereon. The indication referred to here includes, in addition to indication performed by affixing a sticker having the plate ID printed thereon, for example, indication performed by directly printing the plate ID onto the plate 18.

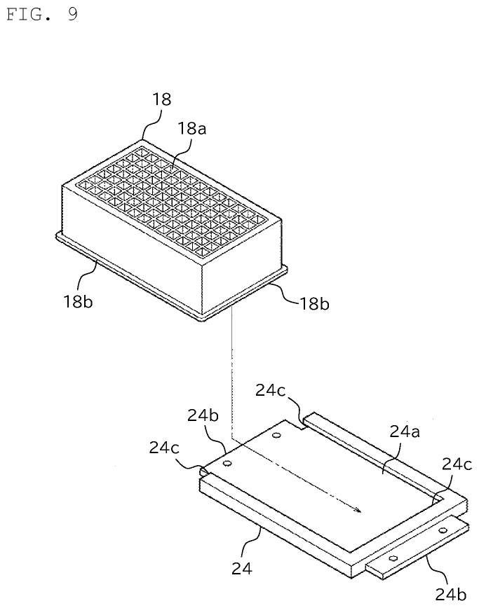

As illustrated in FIG. 9, in this embodiment, a container including ninety-six (eight vertically and twelve horizontally) rectangular wells (plate holes 18a) is used as the plate 18. This plate 18 is configured such that reference symbols of A to H are allocated to the column (X-axis) and numbers of 1 to 12 are allocated to the row (Y-axis) so that the plate hole 18a can be identified through use of a combination of this reference symbol and this number.

On an outer periphery of the plate 18, a fitting portion 18b is provided to project outward. The fitting portion 18b fits to a fitting groove 24c of a plate seat 24 to be described later. The plate 18 shown here is merely an example, and other containers can be used as the plate 18. The plate 18 can be expanded to a plurality of plates.

The plate 18 is set to the plate seat 24 fixed to the setting stand 10. The plate seat 24 in this embodiment includes a placing surface 24a having a rectangular shape in plan view. A flange 24b is provided to the plate seat 24 to project from the plate seat 24, and this flange 24b can be fixed to the setting stand 10 with a fastener such as a screw.

The fitting groove 24c is formed on three sides of the placing surface 24a of the plate seat 24, and the plate 18 is fixed to the plate seat 24 by only fitting the fitting portion 18b of the plate 18 to this fitting groove 24c. The remaining one side of the placing surface 24a is opened, and the fitting portion 18b of the plate 18 can be inserted into the fitting groove 24c from this side. The plate seat 24 can be expanded in accordance with the number of the plates 18.

The tip rack 19 is a container for storing new tips Z to be mounted to the pipette P. In this embodiment, a container including one-hundred (ten vertically and ten horizontally) tip storing portions is used as the tip rack 19. Other containers can also be used as the tip rack 19.

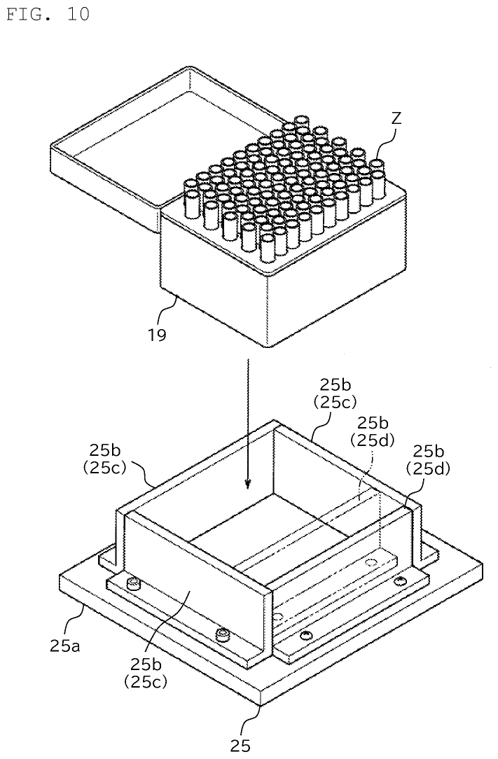

In this embodiment, the tip rack 19 is stored in a tip rack case 25 so that the tip rack 19 can be positioned or adjusted in position. As an example, the tip rack case 25 illustrated in FIG. 10 (a) and FIG. 10 (b) includes a base portion 25a to be fixed to the setting stand 10, and an upright portion 25b provided upright with respect to the base portion 25a. The upright portion 25b is formed of three fixed walls 25c and one movable wall 25d which surround the four sides. The movable wall 25d is moved as appropriate so that the area on the inner side of the upright portion 25b can be adjusted.

The tip rack 19 varies in size and shape depending on the manufacturer, but, as in this embodiment, when the movable wall 25d that can be moved is provided so that the area on the inner side of the upright portion 25b can be adjusted, it is possible to respond flexibly to tip racks 19 having different sizes and shapes. The movable wall 25d after being moved is fixed to the base portion 25a with a screw (not shown) or the like so as to prevent the movable wall 25d from being unexpectedly moved.

When the tip rack 19 is mounted to the tip rack case 25 structured as described above, the tip rack 19 has its four corners positioned at parts matching the four corners of the tip rack case 25. Thus, the position of the origin is less liable to be shifted, and hence the mounting of the tip Z onto the distal end of the pipette P can be reliably performed.

The tip remover 20 is a jig for removing the used tip Z which is mounted on the distal end of the pipette P. The tip remover 20 in this embodiment includes a fixed portion 20a fixed to the setting stand 10, a rising portion 20b rising upward from the fixed portion 20a, and a projecting portion 20c provided at a middle stage of the rising portion 20b so as to project outward.

At a distal end of the projecting portion 20c, the locking recessed portion 20d capable of receiving the coupled part C between the pipette P and the tip Z is provided. When the pipette P is moved upward under a state in which the coupled part C between the pipette P and the tip Z is hooked at the peripheral edge of this locking recessed portion 20d, the tip Z can be removed from the pipette P.

The monitor 21 displays an operating state of the system, an image acquired by the image acquiring means 14, a signal read by the reading means 13, and the like. In this embodiment, buttons for operating an application, such as start, restart, stop, reading, resampling, and the like of the operation, are also displayed on the monitor 21.

The input/output port 23 is means for performing input or output of a signal. In this embodiment, a general-purpose input/output (GPIO) that can be used for input and output is used as the input/output port 23. The GPIO can receive a signal transmitted from the PC 40 to control the tube vice 16. The input/output port 23 is connected to a second power supply 22b shared by the tube vice 16, and operates with power supplied from the second power supply 22b.

The usage of the GPIO as the input/output port 23 provides an advantage in that all of various devices forming the system can be controlled on the PC 40 side. In this manner, control to be performed on the robot 30 side is reduced, and improvement of the processing speed of the robot 30 can be expected. Further, when the control of various devices forming the system is allowed on the PC 40 side, various robots 30 other than the robot 30 used in this embodiment can also use the various devices forming the system, resulting in an advantage in that requests of the customer may be easily responded.

The robot 30 is a robot for handling the tube X and the pipette P. In this embodiment, a double-arm-type articulated robot including the first arm 31 and the second arm 32 is used as the robot 30. The first hand 31a is provided on the first arm 31, and the second hand 32a is provided on the second arm 32. Those first and second hands 31a and 32a hold the tube X and the pipette P.

As illustrated in FIG. 7, control means 33 is mounted on (built into) the robot 30, and the control means 33 controls the first arm 31 and the second arm 32. The robot arm may return back to the origin as appropriate, and may start a new operation from there.

In this embodiment, the first arm 31 performs at least grasping of the tube X stored in the tube rack 11, moving of the tube X to the reading position, moving of the tube X to the image acquiring position, moving of the tube X to the tube vice 16, uncapping of the tube X clamped by the tube vice 16, disposing of the removed cap Y to the cap collection box 17, capping of the tube X and storing of the tube X after capping into the tube rack 11, and operating of the push button PB of the pipette P.

Further, in this embodiment, the second arm 32 performs at least various operations of the pipette P, moving of the pipette P to the tip mounting position, moving of the tip Z to the image acquiring position, and moving of the tip Z to the tip remover 20.

In the robot 30, operation information, such as an operation start-point position, an operation end-point position, an operation path, a momentary pause position, an operation speed, and an operation angle, a branching method, and the like are registered. The first arm 31, the second arm 32, the first hand 31a, and the second hand 32a of the robot 30, and the like are operated in accordance with those pieces of operation information, branching method, and the like. Numerical values or the like of those items can be freely set and changed in accordance with the characteristics of the specimen being a processing target, and the like.

Various existing liquid crystal displays such as one compatible with a touch panel can be used as the monitor 21. With regard to the information to be displayed on the monitor 21, information required by the customer can be displayed after being selected as appropriate in accordance with the requests of the customer.

The PC 40 issues a command with respect to the control means 33 of the robot 30, and also performs reception and recording of data (execution information) transmitted from the reading means 13, the image acquiring means 14, and the like, various kinds of processing such as determination, control of various kinds of means, such as the reading means 13, the image acquiring means 14, the lighting unit 15, the monitor 21, and the power supply 22, answering the determination result with respect to the question from the robot 30, and the like.

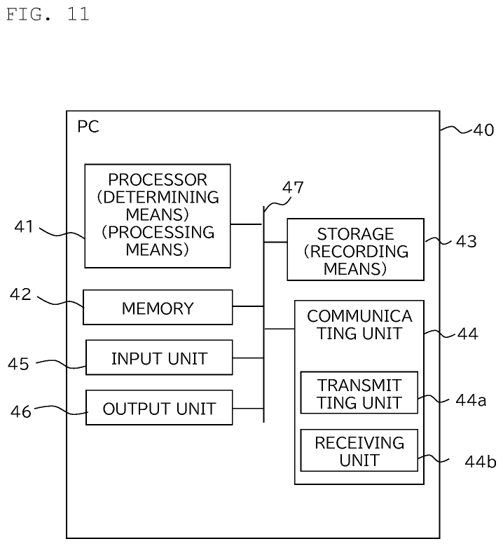

As illustrated in FIG. 11, the PC 40 in this embodiment includes the processor 41, a memory (main storage device) 42, the storage (auxiliary storage device) 43, a communicating unit 44, an input unit 45, and an output unit 46. The communicating unit 44 includes a transmitting unit 44a and a receiving unit 44b. Those elements are electrically connected to each other via a bus 47.

The processor 41 has a function as determining means for determining whether or not uncapping has succeeded, determining whether or not tip mounting has succeeded, determining the drawn amount, determining the expelled amount, and determining whether or not capping has succeeded. The storage 43 has a function as recording means for recording various kinds of execution information. The communicating unit 44 has a function as communicating means for transmitting and receiving information to and from a customer-side system (external device) 50 to be described later.

Further, the processor 41 in this embodiment also functions as processing means for performing, when a phenomenon that hinders the determination of the expelled amount as the film or the like F has occurred, processing so that the determination is prevented from being hindered by this phenomenon. The processing to be executed by the processing means is as described above.

As illustrated in FIG. 7, the system in this embodiment is communicably connected to the customer-side system 50 via a communication line L, and is configured to transfer information used in the system and information obtained by the dispensing work in the system to/from the customer-side e system 50. The communication line L may be wireless or wired. The communication between the system in this embodiment and the customer-side system 50 can also be performed via a record falsification preventing device (not shown).

From a customer-side DB 51 of the customer-side system 50, for example, a registered specimen ID registered on the customer DB side is acquired. Further, when a plurality of plates 18 are to be used, pieces of information on a designated plate ID and a designated plate hole are also acquired from the customer-side DB 51.

The transfer of data to/from the customer-side system 50 can be performed in accordance with a specification designated by the customer, such as CSV linkage and API linkage. Further, required information varies depending on the customer, and any execution information selected and set from among pieces of execution information recorded on the system side can be provided to the customer-side system 50.

This pre-processing executing system operates by means of software (program) for executing each of the process steps. This software can also be provided as a program separated from the pre-processing executing system, specifically, a program for causing a computer to operate as this pre-processing executing system or the execution-information recording device of the present invention. The computer referred to here is only required to include a functional unit corresponding to the processor or the memory, and is a concept including, in addition to the PC 40 forming this system, the robot 30, the whole of this system, and various devices forming this system.

The program is not required to be stored in one computer (for example, the PC 40), and may be stored in both of the PC 40 and the robot 30, or one or two or more of the various devices forming this system. In short, the program referred to here means a program for allowing each of the process steps to be executed.

The software can be provided by a method that enables the software to be downloaded, or can be provided as a recording medium having the software recorded therein in a computer-readable form. The recording medium referred to here includes, for example, an optical disk, an optical magnetic disk, and a semiconductor memory, specifically, for example, a hard disk (HD), a CD-ROM, a CD-R, a CD-RW, a DVD-ROM, a DVD-R, a DVD-RW, a DVD-RAM, a MO, a DVD, a flash memory, and a memory card.

In the flow of the pre-processing and the system for executing the pre-processing in the embodiment, the execution information is automatically recorded in association with the specimen ID (read specimen ID) or the plate ID (read plate ID), and hence double checking of the specimen can be reliably performed.

In the flow of the pre-processing and the system for executing the pre-processing in the embodiment, not only the execution information in a case in which the system operates normally, but also the execution information in a case in which the processing is executed in a procedure or a condition other than the processing procedure or the processing condition determined as a normal operation in the protocol, such as a case in which the robot 30 stops, is recorded. Thus, during the execution of the pre-processing or after the pre-processing is finished, whether or not the pre-processing is performed as in the protocol by the robot 30 can be verified.

The flow of the pre-processing and the system for executing the pre-processing in the embodiment have an advantage in that human errors, such as forgetting to record, record mistake, and record omission, do not occur. The specimen stored in the tube X cannot be identified by the specimen ID after the specimen is once drawn from the tube X, and hence it is required to record information on which specimen is dispensed in which hole of which plate.

Hitherto, this recording has often been performed manually by a worker, but the hands of the worker are sometimes full during the work, and it has been difficult to perform the work and the recording at the same time. In this case, the recording is performed after the work is finished, but, in some cases, there has occurred human errors, such as forgetting to record, record mistake, and record omission.

In contrast, in the flow of the pre-processing and the system for executing the pre-processing in the embodiment, the execution information obtained in the process of pre-processing is automatically recorded, and hence the worker is almost not required to manually perform the recording work. Thus, human errors to be caused when the worker manually performs the recording work do not occur, resulting in that the burden of the worker can be reduced.

The flow of the pre-processing and the system for executing the pre-processing in the embodiment are merely examples, and are not limited to the configuration of the embodiment. Modifications, such as exchange and omission, can be added as appropriate to the flow of the pre-processing and the system for executing the pre-processing without departing from the gist thereof.

### INDUSTRIAL APPLICABILITY

The present invention can be used particularly suitably at the time of pre-processing to be performed before the test using a specimen, for example, pre-processing to be performed before tests using various specimens collected from human, various animals (such as mammals, fish, birds, amphibians, and reptiles), insects, shellfish, crops, plants, seeds and seedlings thereof, microorganisms, and the like.

### REFERENCE SIGNS LIST

10 setting stand
11 tube rack
11a storing recessed portion
12 cap rack
12a cap storing portion
13 reading means
14 image acquiring means
15 lighting unit
16 tube vice
16a clamping portion
16b drive mechanism
16c clamping piece (fixed clamping piece)
16d clamping piece (movable clamping piece)
16e base plate
16f clamping piece seat
16g cushioning member (on fixed clamping piece side)
16h cushioning member (on movable clamping piece side)
16i coupling
16j ball screw
16k linear guide
16m guide supporter
16n T-shaped plate
16p guide block
16M drive source (motor)
17 cap collection box
18 expelling destination container (deep well plate (plate))
18a plate hole
18b fitting portion
19 tip rack
20 tip remover
20a fixed portion
20b rising portion
20c projecting portion
20d locking recessed portion
21 monitor
22 power supply
22a first power supply
22b second power supply
23 input/output port
24 plate seat
24a placing surface
24b flange
24c fitting groove
25 tip rack case
25a base portion
25b upright portion
25c fixed wall
25d movable wall
30 robot
31 first robot arm (first arm)
31a hand of first arm (first hand)
32 second robot arm (second arm)
32a hand of second arm (second hand)
33 control means
40 electronic computer (PC)
41 processor
42 memory (main storage device)
43 storage (auxiliary storage device)
44 communicating unit
44a transmitting unit
44b receiving unit
45 input unit
46 output unit
47 bus
50 customer-side system (external device)
51 customer-side database (customer-side DB)
C coupled part
F film or the like
L communication line
P pipette
PB push button
S1 air part
S2 specimen part
S3 remaining specimen part
X specimen container (tube)
Y cap
Z tip

1. An execution-information recording method for recording execution information obtained when pre-processing to be performed before a test using a specimen is executed in accordance with a protocol set in advance,
the pre-processing including a step of expelling a specimen in a specimen aspirating/discharging unit to an expelling destination container, the execution-information recording method comprising the steps of:
acquiring an image of the specimen aspirating/discharging unit after the expelling of the specimen;
performing, when a phenomenon that hinders determination of an expelled amount of the specimen has occurred in the specimen aspirating/discharging unit, processing so that the determination is prevented from being hindered by the phenomenon; and
recording an evidence obtained by the acquiring of an image and an evidence after the processing in association with each other.

2. The execution-information recording method according to claim 1,
wherein the test using a specimen is a test of analyzing a base sequence of a nucleic acid or an amino acid sequence.

3. The execution-information recording method according claim 1, wherein the test using a specimen is a test using a specimen liquid obtained by adding a buffer solution to a specimen.

4. The execution-information recording method according to claim 1, wherein the test using a specimen is a test using a sequencer.

5. The execution-information recording method according to claim 1, wherein the phenomenon that hinders the determination is a film or air bubbles caused in the specimen aspirating/discharging unit.

6. The execution-information recording method according to claim 1, wherein the phenomenon that hinders the determination is caused due to characteristics of a buffer solution.

7. The execution-information recording method according to claim 1, wherein the evidence obtained by the acquiring of an image is subjected to processing so that the determination of the expelled amount of the specimen is prevented from being hindered by the phenomenon.

8. The execution-information recording method according to claim 1, wherein the evidence obtained by the acquiring of an image is partially hidden or removed so that the determination of the expelled amount of the specimen is prevented from being hindered by the phenomenon.

9. The execution-information recording method according to claim 1, wherein the determination of the expelled amount of the specimen is performed based on the evidence after the processing.

10. The execution-information recording method according to claim 9, further comprising recording an expelled amount determination result obtained by the determination, in association with the evidence obtained by the acquiring of an image and the evidence after the processing.

11. The execution-information recording method according to claim 1,
wherein the pre-processing includes a step of closing a cap of a specimen container after drawing of the specimen, and
wherein the execution-information recording method further comprises the steps of:
determining whether or not the specimen container after the drawing of the specimen is capped; and
recording a capping determination result obtained by the determination in association with specimen identification information for identifying the specimen.

12. The execution-information recording method according to claim 1, wherein the evidence obtained by the acquiring of an image and the evidence after the processing are recorded in association with specimen identification information for identifying the specimen or/and expelling destination identifying information for identifying an expelling destination of the specimen.

13. An execution-information recording device for recording execution information obtained when pre-processing to be performed before a test using a specimen is executed in accordance with a protocol set in advance,
the pre-processing including a step of expelling a specimen in a specimen aspirating/discharging unit to an expelling destination container, the execution-information recording device comprising:
image acquiring means for acquiring an image of the specimen aspirating/discharging unit after the expelling of the specimen;
processing means for performing, when a phenomenon that hinders determination of an expelled amount of the specimen has occurred in the specimen aspirating/discharging unit, processing so that the determination is prevented from being hindered by the phenomenon; and
recording means for recording an evidence obtained by the acquiring of an image and an evidence after the processing performed by the processing means in association with each other.

14. The execution-information recording device according to claim 13, wherein the test using a specimen is a test of analyzing a base sequence of a nucleic acid or an amino acid sequence.

15. The execution-information recording device according to claim 13, wherein the test using a specimen is a test using a specimen liquid obtained by adding a buffer solution to a specimen.

16. The execution-information recording device according to claim 13, wherein the test using a specimen is a test using a sequencer.

17. The execution-information recording device according to claim 13, wherein the phenomenon that hinders the determination is a film or air bubbles caused in the specimen aspirating/discharging unit.

18. The execution-information recording device according to claim 13, wherein the phenomenon that hinders the determination is caused due to characteristics of a buffer solution.

19. The execution-information recording device according to claim 13, wherein the evidence obtained by the acquiring of an image by the image acquiring means is subjected to processing by the processing means so that the determination of the expelled amount of the specimen is prevented from being hindered by the phenomenon.

20. The execution-information recording device according to claim 13, wherein the evidence obtained by the acquiring of an image by the image acquiring means is partially hidden or removed by the processing means so that the determination of the expelled amount of the specimen is prevented from being hindered by the phenomenon.

21. The execution-information recording device according to claim 13, further comprising determining means for making the determination of the expelled amount of the specimen based on the evidence after the processing.

22. The execution-information recording device according to claim 21, wherein an expelled amount determination result obtained by the determination by the determining means is recorded in the recording means, in association with the evidence obtained by the acquiring of an image by the image acquiring means and the evidence after the processing by the processing means.

23. The execution-information recording device according to claim 13,
wherein the pre-processing includes a step of closing a cap of a specimen container after drawing of the specimen, and
wherein whether or not the specimen container after the drawing of the specimen is capped is determined by the determining means; and
wherein a capping determination result obtained by the determination by the determining means is recorded in the recording means in association with specimen identification information for identifying the specimen.

24. The execution-information recording device according to claim 13, wherein the evidence obtained by the acquiring of an image and the evidence after the processing are recorded in the recording means in association with specimen identification information for identifying the specimen or/and expelling destination identifying information for identifying an expelling destination of the specimen.

25. A program for causing a computer to operate as the execution-information recording device of any one of claims 13 to 24.

26. A computer-readable recording medium having the program of claim 25 recorded thereon.

27. An execution-information transmitting method for transmitting, to an external device, execution information obtained when pre-processing to be performed before a test using a specimen is executed in accordance with a protocol set in advance,
the execution-information transmitting method comprising transmitting, to the external device via a communication line, one or two or more pieces of execution information selected from among pieces of execution information recorded by the execution-information recording method of any one of claims 1 to 12.

28. An execution-information transmitting device for transmitting, to an external device, execution information which is a record obtained when pre-processing to be performed before a test using a specimen is executed in accordance with a protocol set in advance,
the execution-information transmitting device comprising a communicating unit configured to transmit, to the external device via a communication line, one or two or more pieces of execution information selected from among pieces of execution information recorded in recording means by the execution-information recording device of any one of claims 13 to 24.
